(19) United States
(12) Patent Application Publication
(10) Pub. No.: US 2013/0095858 A1
(43) Pub. Date: Apr. 18, 2013

(54) METHOD AND APPARATUS FOR PROVIDING SERVICE AND SERVICE INTERFACE BASED ON POSITION

(71) Applicants: Ho-jun Lee, Hwaseong-si (KR); Yong-gook Park, Yongin-si (KR); Tae-young Kang, Seoul (KR); Hee-chul Jeon, Suwon-si (KR)

(72) Inventors: Ho-jun Lee, Hwaseong-si (KR); Yong-gook Park, Yongin-si (KR); Tae-young Kang, Seoul (KR); Hee-chul Jeon, Suwon-si (KR)

(73) Assignee: Samsung Electronics Co., Ltd., Suwon-si (KR)

(21) Appl. No.: 13/589,714

(22) Filed: Aug. 20, 2012

(30) Foreign Application Priority Data
Oct. 14, 2011 (KR) 10-2011-0105527

(51) Int. Cl. H04W 64/00

(52) U.S. Cl. 455/456.3

(57) ABSTRACT

A method and apparatus for providing a position-based service is provided. The method includes detecting a current position; determining whether the current position is included in a previously set area-of-interest; and scanning for a wireless transceiver in response to a determination that the current position is included in the set area-of-interest.

### PRIORITY

This application claims priority under 35 U.S.C. §119(a) to Korean Patent Application No. 10-2011-0105527, filed on Oct. 14, 2011, in the Korean Intellectual Property Office, the entire contents of which is incorporated herein by reference.

### BACKGROUND OF THE INVENTION

1. Field of the Invention

The present invention relates generally to a method and apparatus for providing a service and a service interface based on a position, and more particularly, to a method and apparatus for providing a service and a service interface based on a position by scanning for a wireless transceiver according to a condition.

2. Description of the Related Art

Currently, in order to search a Wireless Fidelity (WiFi) network for an Access Point (AP), a user must turn on a WiFi switch in a setup mode of a terminal to receive information regarding adjacent APs. Users currently do not have a way to designate an AP scanning method.

### SUMMARY OF THE INVENTION

The present invention provides a method and apparatus for providing a service and a service interface based on a position by automatically scanning for a wireless transceiver according to an area-of-interest set by a terminal or motion information of the terminal.

According to an aspect of the present invention, a method of providing a position-based service in a service providing device is provided. The method includes detecting a current position; determining whether the current position is included in a previously set area-of-interest; and scanning for a wireless transceiver in response to a determination that the current position is included in the set area-of-interest.

According to another aspect of the present invention, a method of providing a position-based service interface in a service providing device is provided. The method includes providing an area-of-interest setup interface for supporting at least one of a text-based input interface, a map-based input interface, and a current-position-based input interface to set an area-of-interest; and determining whether to scan for a wireless transceiver according to the set area-of-interest.

According to another aspect of the present invention, an apparatus for providing a position-based service is provided. The apparatus includes a position recognition unit for detecting a current position; and a control unit for determining whether the current position is included in a previously set area-of-interest, and scanning for a wireless transceiver in response to a determination that the current position is included in the set area-of-interest.

According to another aspect of the present invention, an apparatus for providing a position-based service interface, the apparatus providing an area-of-interest setup interface for supporting at least one of a text-based input interface, a map-based input interface, and a current-position-based input interface to set an area-of-interest, wherein the area-of-interest is a reference area for determining whether to scan for a wireless transceiver.

According to another aspect of the present invention, a non-transitory computer-readable recording medium having recorded thereon a computer program for executing a method of providing a position-based service in a service providing device is provided. The method includes detecting a current position; determining whether the current position is included in a previously set area-of-interest; and scanning for a wireless transceiver in response to a determination that the current position is included in the set area-of-interest.

According to another aspect of the present invention, a non-transitory computer-readable recording medium having recorded thereon a computer program for executing a method of providing a position-based service interface in a service providing device is provided. The method includes providing an area-of-interest setup interface for supporting at least one of a text-based input interface, a map-based input interface, and a current-position-based input interface to set an area-of-interest; and determining whether to scan for a wireless transceiver according to the set area-of-interest.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a position-based service providing system according to an embodiment of the present invention;

FIG. 2 is a flowchart illustrating a position-based service providing method according to an embodiment of the present invention;

FIG. 3 is a flowchart illustrating an area-of-interest setup interface providing method according to an embodiment of the present invention;

FIG. 4 is a diagram illustrating a screen of an area-of-interest setup interface, according to an embodiment of the present invention;

FIG. 5 is a diagram illustrating a screen of a text-based area-of-interest setup interface, according to an embodiment of the present invention;

FIG. 6 is a diagram illustrating a screen of a map-based area-of-interest setup interface, according to an embodiment of the present invention;

FIG. 7 is a diagram illustrating a screen of a current-position-based area-of-interest setup interface, according to an embodiment of the present invention;

FIG. 8 is a flowchart illustrating a position-based service providing method according to another embodiment of the present invention; and

FIG. 9 is a block diagram illustrating a position-based service providing apparatus according to an embodiment of the present invention.

### DETAILED DESCRIPTION OF EMBODIMENTS OF THE PRESENT INVENTION

Embodiments of the present invention are described in detail as follows with reference to the accompanying drawings. In the following description, specific details such as detailed configuration and components are merely provided to assist the overall understanding of the embodiments of the present invention. Therefore, it should be apparent to those skilled in the art that various changes and modifications of the embodiments described herein can be made without departing from the scope and spirit of the invention. In addition, descriptions of well-known functions and constructions may be omitted for clarity and conciseness.

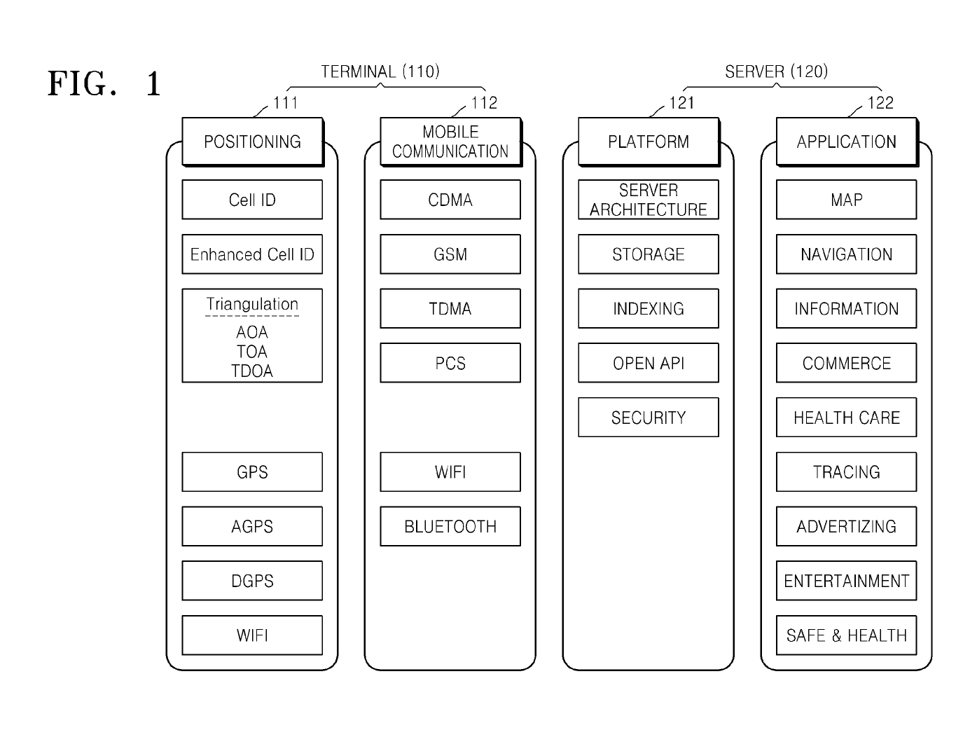

FIG. 1 is a block diagram illustrating a position-based service providing system according to an embodiment of the present invention.

Referring to FIG. 1, the system according to an embodiment of the present invention includes a terminal 110 and a server 120. The terminal 110 includes a positioning module 111 and a mobile communication module 112. The server 120 includes a platform 121 and an application 122.

The positioning module 111 is checks a position of the terminal 110 by using technology such as cell IDentifier (ID) positioning, enhanced cell ID positioning, triangulation using an Angle of Arrival (AoA), a Time of Arrival (ToA), or a Time Difference of Arrival (TDoA), Global Positioning System (GPS), Assisted GPS (AGPS), Differential GPS (DGPS), or Wireless Fidelity (WiFi). However, the positioning module 111 is not limited these positioning technologies, and other positioning technologies may be used in accordance with embodiments of the present invention.

The mobile communication module 112 provides communication between the terminal 110 and the server 120 through use of mobile communication technology such as Code Division Multiple Access (CDMA), Global System for Mobile communications (GSM), Time Division Multiple Access (TDMA), or Personal Communication Service (PCS), and/or short-distance communication technology such as WiFi or Bluetooth. However, the mobile communication module 112 is not limited to these communication technologies, and other communication technologies may be used in accordance with embodiments of the present invention.

The platform 121 may use technology such as server architecture, storage, indexing, open Application Programming Interface (API), and/or security technologies. The server architecture technology is a position-based processing technology for obtaining position information from a position obtaining server and performing position-based functions such as position information providing, position information management, position information processing of an individual or a group, and movement tracing in response to a request of a terminal (e.g., a client terminal). The storage technology is used for storing and managing large amounts of information. The indexing technology is used for optimally systematizing position information itself or its related information to allow the information to be easily found. The open API technology is used for providing position information or its related information in association with another service provider. The security technology is used for blocking access to certain users by managing, authenticating, and securing user profiles. However, the platform 121 is not limited to these technologies, and other technologies may be used in accordance with embodiments of the present invention.

The application 122 provides a position-based service ultimately to the terminal 110. Examples of such applications include map, navigation, information, commerce, health care, tracing, advertizing, entertainment, and safety & health applications. However, the application 122 is not limited to these applications, and other applications may be used in accordance with embodiments of the present invention.

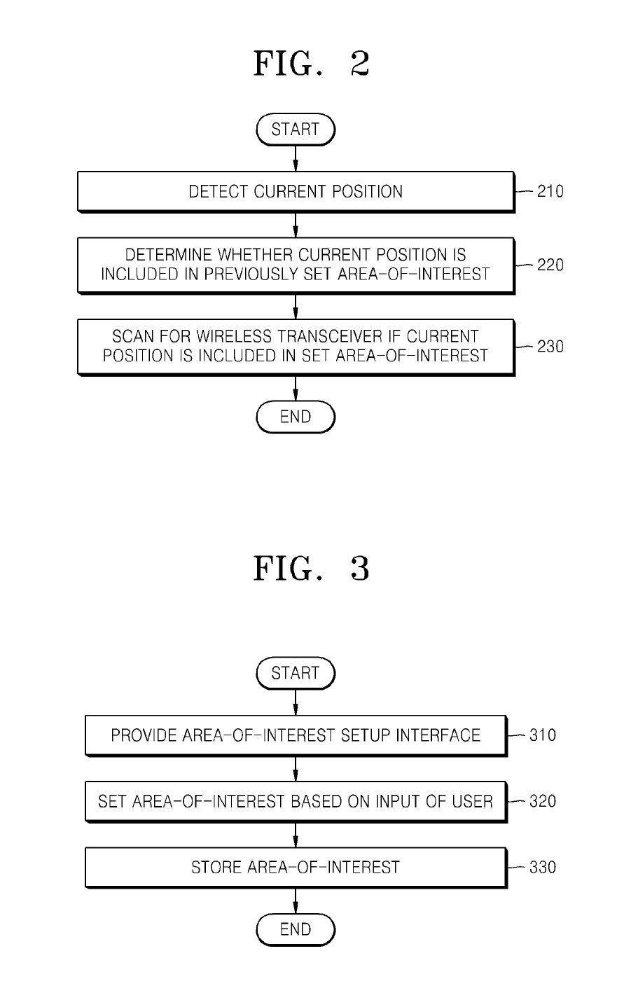

FIG. 2 is a flowchart illustrating a position-based service providing method according to an embodiment of the present invention.

Referring to FIG. 2, in step 210, an apparatus for performing the position-based service providing method (hereinafter referred to as a “position-based service providing apparatus”) detects a current position. The position-based service providing apparatus may extract and detect GPS information. Any of various methods of detecting the current position may be used in accordance with embodiments of the present invention.

In step 220, the position-based service providing apparatus determines whether the current position is included in a previously set area-of-interest. An area-of-interest is an area set by a user via an area-of-interest setup interface in order to receive a position-based service, and may include range-restricted location information. An area-of-interest setup interface providing method is described in further detail herein below with reference to FIG. 3.

In step 230, the position-based service providing apparatus scans for a wireless transceiver, if the current position is included in the set area-of-interest. If the position-based service providing apparatus is in an area-of-interest, the position-based service providing apparatus scans for a wireless transceiver (e.g., an Access Point (AP)) by activating a module for scanning for the wireless transceiver. If the wireless transceiver is detected through the scanning operation, the position-based service providing apparatus (or a terminal including the position-based service providing apparatus) may store information regarding the detected wireless transceiver and may receive signals transmitted from the detected wireless transceiver.

FIG. 3 is a flowchart illustrating an area-of-interest setup interface providing method according to an embodiment of the present invention.

Referring to FIG. 3, in step 310, an apparatus for performing the area-of-interest setup interface providing method (hereinafter referred to as an “area-of-interest setup interface providing apparatus”) provides an area-of-interest setup interface to a user. The area-of-interest setup interface supports at least one of a text-based input method, a map-based input method, and a current-position-based input method. However, the area-of-interest input method is not limited to these input methods, and other input methods may be used in accordance with embodiments of the present invention.

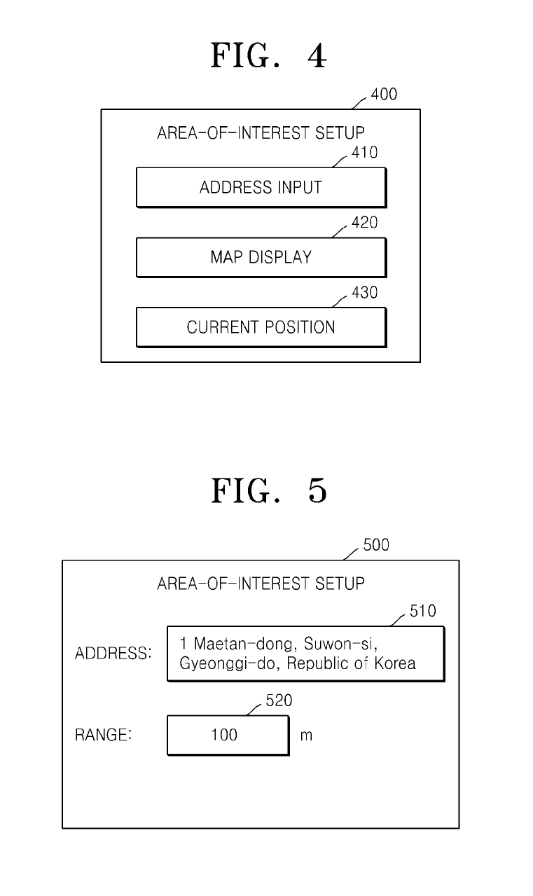

FIG. 4 is a diagram illustrating a screen of an area-of-interest setup interface 400, according to an embodiment of the present invention.

Referring to FIG. 4, the area-of-interest setup interface 400 includes an address input menu 410 that uses a text-based input method, a map display menu 420 that uses a map-based input method, and a current position menu 430 using a current-position-based input method.

If the address input menu 410 is activated, an area-of-interest setup interface supporting the text-based input method is provided. The area-of-interest setup interface for supporting the text-based input method provides a text input menu for inputting text such as an address, and an area range selection menu for setting an area-of-interest by selecting an area range surrounding the input address. Text may be input as an actual address, or may alternatively be input as a name of place (e.g., Seoul station).

FIG. 5 is a diagram illustrating a screen of a text-based area-of-interest setup interface 500 according to an embodiment of the present invention.

Referring to FIG. 5, the text-based area-of-interest setup interface 500 provides a text input menu 510 for inputting text such as an address or a place name, and an area range selection menu 520.

Referring back to FIG. 4, if the map display menu 420 is activated, an area-of-interest setup interface for supporting the map-based input method is provided. The area-of-interest setup interface for supporting the map-based input method displays a stored or downloaded map, and provides a means for a user to select an area range by using a predetermined input means.

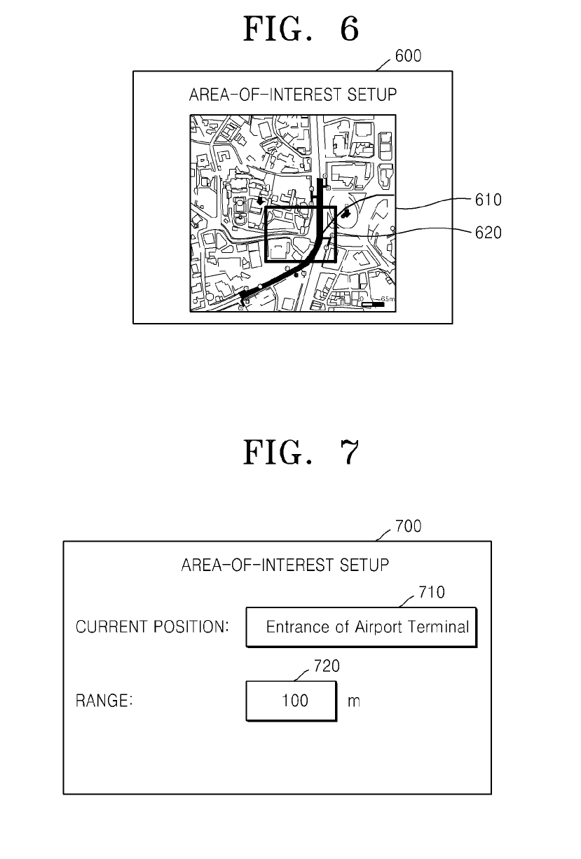

FIG. 6 is a diagram illustrating a screen of a map-based area-of-interest setup interface 600 according to an embodiment of the present invention.

Referring to FIG. 6, the map-based area-of-interest setup interface 600 provides a map 610 and a means 620 for a user to select an area range.

Referring back to FIG. 4, if the current position menu 430 is activated, an area-of-interest setup interface for supporting the current-position-based input method is provided. The area-of-interest setup interface for supporting the current-position-based input method displays a current position and provides an area range selection menu for setting an area-of-interest by selecting an area range with respect to the current position. When the current position is displayed, an address or a place name (e.g., Seoul station) may be displayed.

FIG. 7 is a diagram illustrating a screen of a current-position-based area-of-interest setup interface 700 according to an embodiment of the present invention.

Referring to FIG. 7, the current-position-based area-of-interest setup interface 700 provides a current position display menu 710 and an area range selection menu 720.

Referring back to FIG. 3, in step 320, if an area-of-interest setup signal is received from the user via the area-of-interest setup interface, the area-of-interest setup interface providing apparatus sets an area-of-interest according to the received signal.

In step 330, the area-of-interest setup interface providing apparatus stores the set area-of-interest.

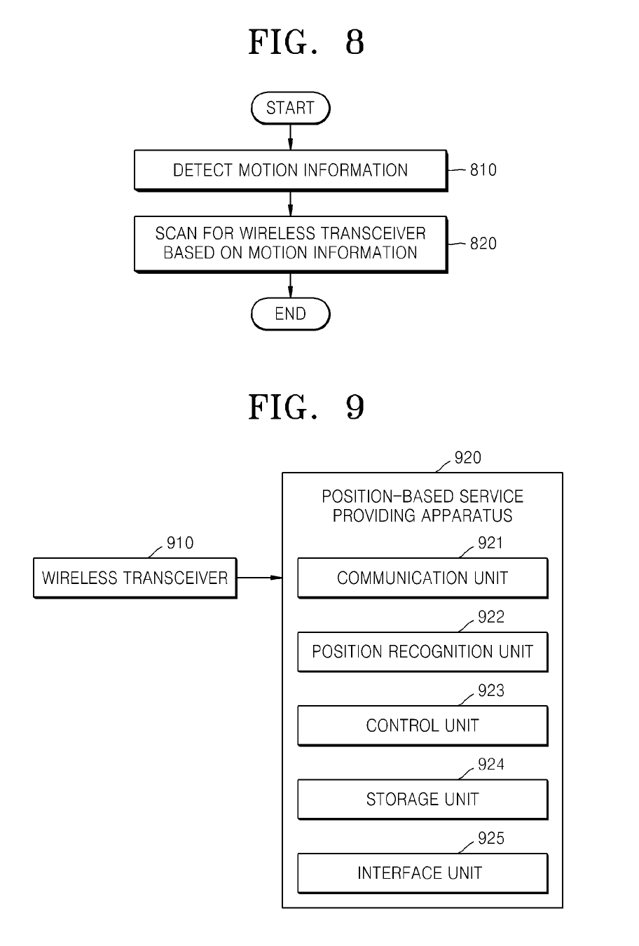

FIG. 8 is a flowchart illustrating a position-based service providing method according to another embodiment of the present invention.

Referring to FIG. 8, in step 810, a position-based service providing apparatus detects motion information of the position-based service providing apparatus by using a predetermined sensor. Examples of the motion information include a speed, a distance, and the number of steps of a user.

In step 820, the position-based service providing apparatus scans for a wireless transceiver, if the detected motion information is beyond a reference range based on previously set motion information. For example, the previously set motion information is set to scan for a wireless transceiver if the speed is at least equal to 10 km/s. As such, if the detected motion information indicates 11 km/s, the position-based service providing apparatus scans for an adjacent wireless transceiver.

FIG. 9 is a block diagram illustrating a position-based service providing apparatus 920 according to an embodiment of the present invention.

Referring to FIG. 9, the position-based service providing apparatus 920 includes a communication unit 921, a position recognition unit 922, a control unit 923, a storage unit 924, and an interface unit 925.

The position recognition unit 922 detects a current position of the position-based service providing apparatus 920. The position recognition unit 922 may extract and detect GPS information. Any of various methods for detecting a current position may be used in accordance with embodiments of the present invention.

The control unit 923 determines whether the current position of the service-providing apparatus 920 is included in an area-of-interest stored in the storage unit 924. The area-of-interest refers to an area set by a user via an area-of-interest setup interface in order to receive a position-based service, and may include range-restricted location information.

The interface unit 925 provides the area-of-interest setup interface to the user. The interface unit 925 supports at least one of a text-based input method, a map-based input method, and a current-position-based input method. However, the area-of-interest input method is not limited thereto, and other input methods may be used in accordance with embodiments of the present invention.

An area-of-interest setup interface for supporting the text-based input method provides a text input menu for inputting text such as an address, and an area range selection menu for setting an area-of-interest by selecting an area range with respect to the address. Either an address or a name of a place (e.g., Seoul station) may be provided as text input. An area-of-interest setup interface for supporting the map-based input method displays a stored or downloaded map, and provides a means for a user to select an area range by using a predetermined input means. An area-of-interest setup interface for supporting the current-position-based input method displays a current position, and provides an area range selection menu for setting an area-of-interest by selecting an area range with respect to the current position. When the current position is displayed, an address or a place name (e.g., Seoul station) may be displayed.

After that the position is input, if the interface unit 925 receives an area-of-interest setup signal from the user, the area-of-interest setup interface providing apparatus 920 sets an area-of-interest and stores the set area-of-interest in the storage unit 924.

If the current position is included in the set area-of-interest, the control unit 923 scans for a wireless transceiver 910. If the position-based service providing apparatus 920 is in the area-of-interest, the control unit 923 scans for the adjacent wireless transceiver 910, e.g., an AP, by activating a module for scanning for the wireless transceiver 910. If the wireless transceiver 910 is detected by scanning, the storage unit 924 stores information regarding the detected wireless transceiver 910, and the communication unit 921 receives signals transmitted from the wireless transceiver 910.

Also, the control unit 923 detects motion information of the position-based service providing apparatus 920 by using a predetermined sensor (not shown). Examples of the motion information include a speed, a distance, and the number of steps of a user. After the motion information is detected, the control unit 923 scans for the wireless transceiver 910, if the detected motion information is beyond a reference range based on previously set motion information stored in the storage unit 924. For example, the previously set motion information may be set to scan for the wireless transceiver 910 if the speed is equal to or greater than 10 km/s. Accordingly, if the detected motion information indicates 11 km/s, the control unit 923 scans for the adjacent wireless transceiver 910.

The present invention can also be implemented as computer-readable code on a computer-readable recording medium. The computer-readable recording medium may be any data storage device that can store data that can be thereafter read by a computer system. Examples of the computer-readable recording medium include Read-Only Memory (ROM), Random-Access Memory (RAM), Compact Disc (CD)-ROMs, magnetic tapes, floppy disks, optical data storage devices, etc. The computer-readable recording medium can also be distributed over network-coupled computer systems so that the computer-readable code is stored and executed in a distributed fashion. Functional programs, codes, and code segments may also be used for accomplishing embodiments the present invention.

While the present invention has been particularly shown and described with reference to certain embodiments thereof, it will be understood by one of ordinary skill in the art that various changes in form and details may be made therein without departing from the spirit and scope of the invention as defined by the following claims. The described embodiments should be considered in a descriptive sense only and not for purposes of limitation. Therefore, the scope of the invention is defined not by the detailed description of the invention but by the following claims, and all differences within the scope and equivalents thereof are to be construed as being included in the present invention.

What is claimed is:

1. A method of providing a position-based service in a service providing device, the method comprising:
detecting a current position;
determining whether the current position is included in a previously set area-of-interest; and
scanning for a wireless transceiver in response to a determination that the current position is included in the set area-of-interest.

2. The method of claim 1, further comprising providing an area-of-interest setup interface for setting the area-of-interest.

3. The method of claim 2, further comprising:
setting the area-of-interest according to user input; and
storing the set area-of-interest.

4. The method of claim 2, wherein the area-of-interest setup interface supports at least one of a text-based input interface, a map-based input interface, and a current-position-based input interface.

5. The method of claim 4, wherein the text-based input interface provides a text input menu and an area range selection menu.

6. The method of claim 4, wherein the map-based input interface provides a map and an area range input menu.

7. The method of claim 4, wherein the current-position-based input interface displays an input current position and provides an area range selection menu.

8. The method of claim 1, further comprising:
detecting motion information of the service providing device; and
scanning for a wireless transceiver if the motion information indicates motion beyond a predetermined motion range.

9. A method of providing a position-based service interface in a service providing device, the method comprising:
providing an area-of-interest setup interface for supporting at least one of a text-based input interface, a map-based input interface, and a current-position-based input interface to set an area-of-interest; and
determining whether to scan for a wireless transceiver according to the set area-of-interest.

10. The method of claim 9, wherein the text-based input interface provides a text input menu and an area range selection menu.

11. The method of claim 9, wherein the map-based input interface provides a map and an area range input menu.

12. The method of claim 9, wherein the current-position-based input interface displays an input current position, and provides an area range selection menu.

13. An apparatus for providing a position-based service, the apparatus comprising:
a position recognition unit for detecting a current position; and
a control unit for determining whether the current position is included in a previously set area-of-interest, and scanning for a wireless transceiver in response to a determination that the current position is included in the set area-of-interest.

14. The apparatus of claim 13, further comprising an interface unit for providing an area-of-interest setup interface for setting the area-of-interest.

15. The apparatus of claim 14, wherein the interface unit sets the area-of-interest based on user input, and stores the set area-of-interest.

16. The apparatus of claim 14, wherein the area-of-interest setup interface supports at least one of a text-based input interface, a map-based input interface, and a current-position-based input interface.

17. The apparatus of claim 16, wherein the text-based input interface provides a text input menu and an area range selection menu.

18. The apparatus of claim 16, wherein the map-based input interface provides a map and an area range input menu.

19. The apparatus of claim 16, wherein the current-position-based input interface displays an input current position, and provides an area range selection menu.

20. The apparatus of claim 13, wherein the control unit detects motion information of the apparatus, and scans for a wireless transceiver if the motion information is beyond a set motion range.

21. An apparatus for providing a position-based service interface, the apparatus providing an area-of-interest setup interface for supporting at least one of a text-based input interface, a map-based input interface, and a current-position-based input interface to set an area-of-interest,
wherein the area-of-interest is a reference area for determining whether to scan for a wireless transceiver.

22. The apparatus of claim 21, wherein the text-based input interface provides a text input menu and an area range selection menu.

23. The apparatus of claim 21, wherein the map-based input interface provides a map and an area range input menu.

24. The apparatus of claim 21, wherein the current-position-based input interface displays an input current position, and provides an area range selection menu.

25. A non-transitory computer-readable recording medium having recorded thereon a computer program for executing a method of providing a position-based service in a service providing device, the method comprising:
detecting a current position;
determining whether the current position is included in a previously set area-of-interest; and
scanning for a wireless transceiver in response to a determination that the current position is included in the set area-of-interest.

26. A non-transitory computer-readable recording medium having recorded thereon a computer program for executing a method of providing a position-based service interface in a service providing device, the method comprising:
providing an area-of-interest setup interface for supporting at least one of a text-based input interface, a map-based input interface, and a current-position-based input interface to set an area-of-interest; and
determining whether to scan for a wireless transceiver according to the set area-of-interest.
